(19) United States
(12) Patent Application Publication
(10) Pub. No.: US 2008/0111698 A1
(43) Pub. Date: May 15, 2008

(54) MOBILE DEVICE POWER MANAGEMENT

(75) Inventor: William E. Atherton, Hillsborough, NC (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: International Business Machines Corporation, Armonk, NY (US)

(21) Appl. No.: 11/558,212

(22) Filed: Nov. 9, 2006

(51) Int. Cl. G01W 1/02; G08B 21/00

(52) U.S. Cl. 340/601; 340/636.1

(57) ABSTRACT

Embodiments of the invention address deficiencies of the art in respect to power management and provide a novel and non-obvious method, system and computer program product for mobile device power management. In one embodiment of the invention, a mobile device power management method can be provided. The method can include sensing environmental conditions associated with the proximity of a mobile device to a human ear and determining a period of inactivity from the sensed environmental conditions. Responsive to determining a period of inactivity from the sensed environmental conditions, the mobile device can be placed in a state of lower power consumption. Optionally, a companion device can be notified of the state of lower power consumption.

### BACKGROUND OF THE INVENTION

1. Field of the Invention

The present invention relates to the field of power management and more particularly to the field of power management in mobile devices.

2. Description of the Related Art

Power management for computing devices first fell into vogue during the brief green era of computing of more than a decade ago. Wall-powered devices previously provided no regulation of the amount of power drawn during operation. During the green era of computing, eco-friendly computing devices managed different computing peripherals in order to reduce power consumption. Most popularly, computer inactivity triggered a screen saver at the minimum and long term inactivity resulted in monitor and hard drive shut down. Battery performance considerations as opposed to eco-friendliness, however, subsequently drove the development of more advanced forms of power management.

The advancement of computing mobility can be compared to the parallel advancement of battery technology. Early mobile devices utilized clunky, poor performing nickel cadmium cells. Subsequent use of nickel metal hydride cells extended battery life sufficient to render some mobile devices, including laptop computers and cell phones to new plateaus of utility. More recently, lithium ion cells have extended the un-tethered usefulness of mobile devices many hours fold. Many laptop computers now enjoy three to four hours of battery-powered range. Personal digital assistants (PDAs) and cellular telephones now need charging only once per day—sometimes only once every few days depending upon use. Notwithstanding, emerging technologies have placed significant power demands on mobile device sufficient to counter newly found extended battery life.

In particular, communications technologies such as Bluetooth and Wi-Fi place a heavy power burden on mobile devices, principally due to the power demands of associated radiofrequency transceivers. In consequence, many mobile devices no longer enjoy long battery life thereby defeating the new found utility of such devices. Notable examples include PDAs, cellular telephones and wireless headsets. Wireless headsets in particular, demonstrate only a brief period of un-tethered utility before requiring recharging.

Mostly, the poor performance of the power supply for wireless headsets can be attributed to the power hungry communications technologies utilized by the wireless headsets and the smallish size of the wireless headsets which inherently limit the size and hence charge of onboard batteries. Of course, transmitting devices such as cellular telephones and PDAs also suffer power drain when interacting with wireless headsets for the same reasons, albeit the charge held by the base device naturally exceeds that of the wireless headset.

### BRIEF SUMMARY OF THE INVENTION

Embodiments of the invention address deficiencies of the art in respect to power management and provide a novel and non-obvious method, system and computer program product for mobile device power management. In one embodiment of the invention, a mobile device power management method can be provided. The method can include sensing environmental conditions associated with the proximity of a mobile device to a human ear and determining a period of inactivity from the sensed environmental conditions. Responsive to determining a period of inactivity from the sensed environmental conditions, the mobile device can be placed in a state of lower power consumption. Optionally, a companion device can be notified of the state of lower power consumption.

In one aspect of the embodiment, sensing environmental conditions associated with a proximity of the mobile device to a human ear can include sensing temperature conditions associated with a proximity of the mobile device to a human ear. In another aspect of the embodiment, sensing environmental conditions associated with a proximity of the mobile device to a human ear can include sensing audio reflectivity conditions associated with a proximity of the mobile device to a human ear. In either case, determining a period of inactivity from the sensed environmental conditions can include determining a period of inactivity based upon a lapsed threshold period of time during which the sensed environmental conditions indicate a lack of proximity of the mobile device to the human ear.

In another embodiment of the invention, a mobile device power management data processing system can be provided. The system can include a central processing unit (CPU) supported by a battery. The system further can include power management logic configured to manage utilization of the battery. Finally, the system can include a proximity sensor coupled to the power management logic. The sensor can include, for instance, a temperature sensor or an audio reflectivity sensor. Importantly, the power management logic can include program code enabled to reduce utilization of the battery based upon a detected close proximity to a human ear.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a mobile device communications partnership configured for mobile device power management;

FIG. 2 is a schematic illustration of a mobile device data processing system configured for mobile device power management;

FIG. 3 is a flow chart illustrating a process for initializing mobile device power management in a mobile device; and,

FIG. 4 is a flow chart illustrating a process for mobile device power management in a mobile device.

### DETAILED DESCRIPTION OF THE INVENTION

Embodiments of the invention provide a method, system and computer program product for mobile device power management. In accordance with an embodiment of the present invention, a mobile device can be associated with a companion computing device in wireless communication with one another. An activity sensor in the mobile device can detect inactivity in the mobile device. In response to detected inactivity, the mobile device can notify the companion computing device to suspend the wireless communications link between the devices. Thereafter, the mobile device can enter a reduced power mode. Subsequently, in response to detected activity, the mobile device can re-enter an active state and the wireless communications link between the devices can resume.

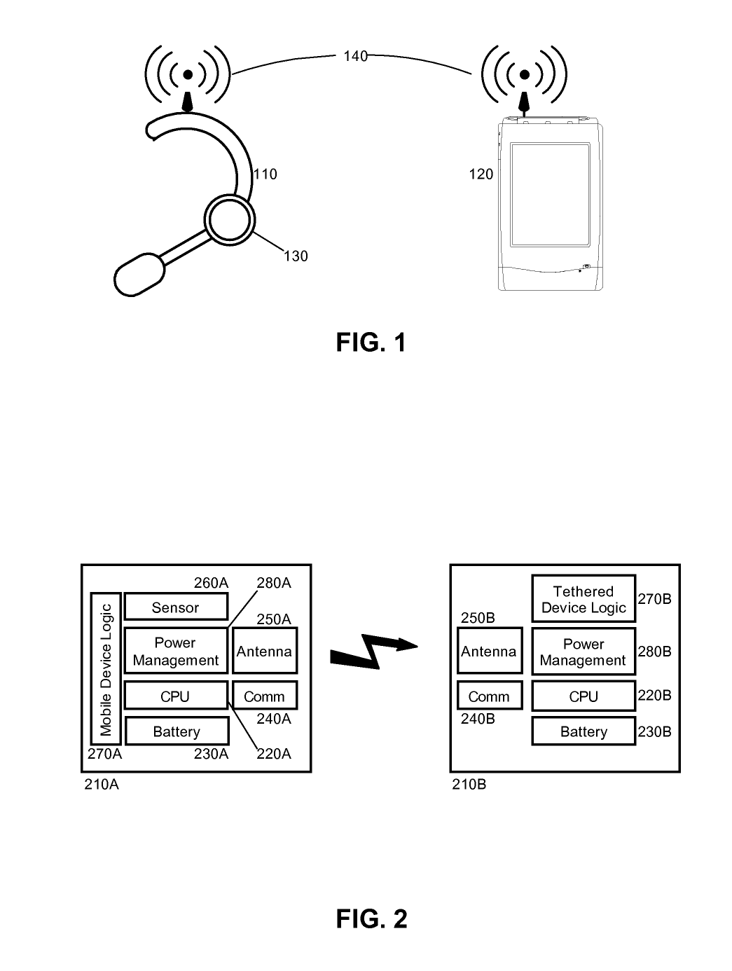

In further illustration, FIG. 1 is a pictorial illustration of a mobile device communications partnership configured for mobile device power management. The communications partnership can include a mobile device 110 communicatively coupled to a companion device 120 over a wireless communications link 140, for example, a radio frequency link. The mobile device 110 and the companion device 120 can be viewed as a partnership to the extent that the operation of the mobile device 110 enhances the functionality and utility of the companion device 120. Examples include wireless headsets for cell phones, PDAs and portable music players.

Importantly, an activity sensor 130 can be disposed in the mobile device 110. The activity sensor 130 can detect environmental conditions indicative of activity. Examples include warmer temperatures consistent with the proximity of the mobile device 110 to the human body such as the outer ear in the case of a wireless headset. Other examples include a reflected audio signal indicative of the proximity of mobile device 110 the human ear in the case of a wireless headset.

When a period of inactivity is concluded by virtue of environmental conditions sensed by the sensor 130, the mobile device 110 can enter into a reduced power consumption mode. Additionally, the mobile device 110 can notice the companion device 120 of the reduced power consumption mode so as to optionally cause the companion device to reduce power consuming operations associated with the maintenance of the wireless communications link 140.

In yet further illustration, FIG. 2 is a schematic illustration of a mobile device data processing system configured for mobile device power management. The system can include a mobile device 210A communicatively coupled to a companion device 210B over a wireless communications link. The mobile device 210A can include a CPU 220A supporting the operation of mobile device logic 270A along with a communications antenna 250A and corresponding communications module 240A enabled to communicate with the companion device 210B. A battery 230A can supply power suitable for the operation of the mobile device 210A and power management module 280A can manage the consumption of power by reducing or suspending computing operations in the mobile device 210A or in a portion of the mobile device 210A such as in a handset only, or in the handset base only.

The companion device 210B similarly can include a CPU 200B supporting the operation of companion device logic 270B along with a communications antenna 250B and corresponding communications module 240B enabled to communicate with the mobile device 210A. A battery 230B can supply power suitable for the operation of the companion device 210B and power management module 280B can manage the consumption of power by reducing or suspending computing operations in the companion device 210B.

Notably, the mobile device 210A can include an activity sensor 260A. The activity sensor 260A can be configured to detect activity in the mobile device 210A. For instance, the activity sensor 260A can be a temperature sensor configured to detect temperature conditions sufficient to indicate the proximity of the human ear. In another instance, the activity sensor 260A can be an audio transducer configured to detect strong reflectivity of audio energy produced in by the mobile device 210A. As the skilled artisan will recognize, the presence of strong reflectivity of audio energy indicates the proximity of the human ear as well.

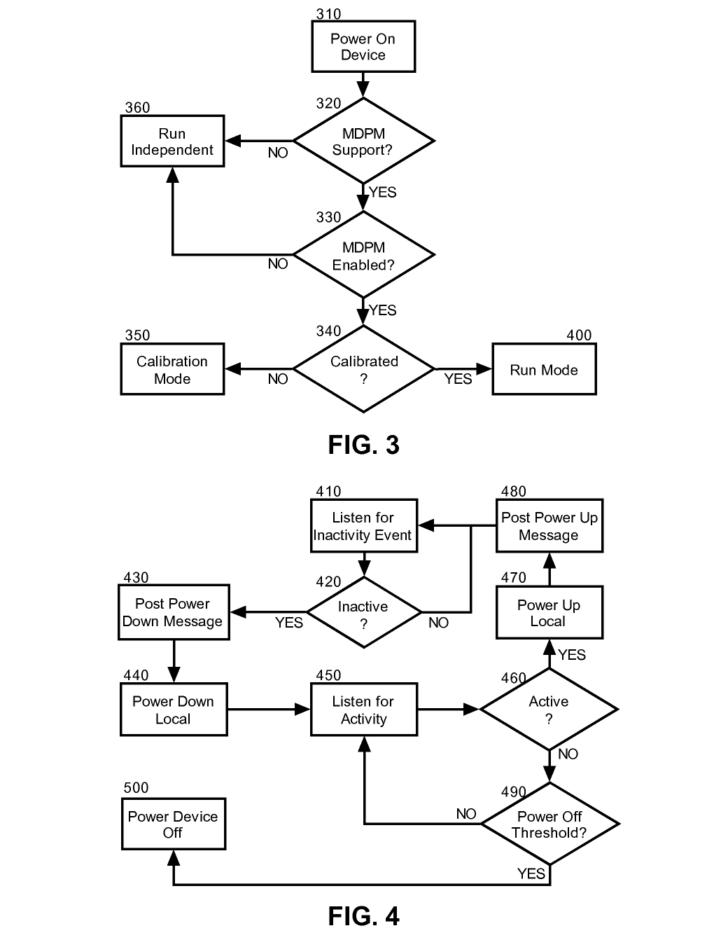

In accordance with an embodiment of the present invention, the power management logic 280A can include program code enable to detect a period of inactivity through the sensor 260A. In response to detecting a period of inactivity, the program code can be enabled to limit power consumption in the mobile device 210A or to otherwise place the mobile device 210 in a suspended mode in order to conserve power consumption or to completely power off the mobile device 210. In more particular illustration of the operation of the power management logic 290A, FIG. 3 is a flow chart illustrating a process for initializing mobile device power management in a mobile device and FIG. 4 is a flow chart illustrating a process for mobile device power management in a mobile device.

Considering FIG. 3, initially, the mobile device can be powered on and in decision block 320, it can be determined whether the mobile device supports power management. If so, in decision block 330, it further can be determined whether power management has been enabled in the mobile device. If not, the process can end in block 360 in which the mobile device can run independently in order to conserve power, to run in association with a single device such as headset only. Otherwise, the process can continue through decision block 340. In decision block 340, it can be determined whether the sensor for the mobile device has been calibrated to properly detect a period of activity and a period of inactivity. If so, the mobile device will have successfully initialized and the mobile power management logic can proceed to a run mode.

Otherwise, in block 350, the sensor can be calibrated through a measurement of an ambient environment and an environment associated with a period of activity in the mobile device such as the close proximity of the mobile device to the human ear. In this regard, where the sensor is a temperature sensor, temperature readings can be acquired both while the mobile device is in proximity to the human ear, and while the mobile device is away from the human ear. Similarly, where the sensor is an audio transducer, audio measurements of reflectivity can be taken in proximity to the human ear and at a distance.

Turning now to FIG. 4, in block 410 the sensor can be monitored to detect an environmental condition associated with a period of inactivity for the mobile device. For example, in the case where the mobile device is a wireless headset, where it is determined that the mobile device is not in close proximity of the human ear for a threshold period of time, it can be presumed that the headset has been removed from the ear and placed in a position of inactivity and nonuse. Conversely, where it is determined that the mobile device is in close proximity to the human ear, it can be presumed that the headset has been placed in use in the human ear.

In decision block 420, if the mobile device is determined to be inactive, in block 430, a power down message can be transmitted to the companion device indicating that it is no longer necessary for the companion device to support substantial interactions with the mobile device (so that the companion device too can conserve power). Thereafter, in block 440 the mobile device can be placed in a lower power consuming state such as a state of computing suspension. Subsequently, in block 450 the sensor can be monitored for activity.

In decision block 460, if activity is detected in the mobile device, in block 470 the mobile device can emerge from the lower power consuming state and a corresponding message can be transmitted to the companion device to resume interaction with the mobile device. In decision block 460, however, if activity is not detected in the mobile device, in decision block 490 it further can be determined if the power-off threshold has been exceeded indicating that the device has remained powered down for too long. If so, in block 500 the device can be powered off completely. Otherwise, the process can return to block 450 in which the sensor can be monitored for activity.

The embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. In a mobile device, a mobile device power management method comprising:
sensing environmental conditions associated with a proximity of the mobile device to a human ear;
determining a period of inactivity from the sensed environmental conditions; and,
responsive to determining a period of inactivity from the sensed environmental conditions, placing the mobile device in a state of lower power consumption.

2. The method of claim 1, further comprising notifying a companion device of the state of lower power consumption.

3. The method of claim 1, further comprising:
continuing to sense environmental conditions associated with a proximity of the mobile device to a human ear;
determining a period of activity from the sensed environmental conditions; and,
responsive to determining a period of activity from the sensed environmental conditions, placing the mobile device in a resumed state of power consumption.

4. The method of claim 1, wherein sensing environmental conditions associated with a proximity of the mobile device to a human ear, comprises sensing temperature conditions associated with a proximity of the mobile device to a human ear.

5. The method of claim 1, wherein sensing environmental conditions associated with a proximity of the mobile device to a human ear, comprises sensing audio reflectivity conditions associated with a proximity of the mobile device to a human ear.

6. The method of claim 1, wherein determining a period of inactivity from the sensed environmental conditions, comprises determining a period of inactivity based upon a lapsed threshold period of time during which the sensed environmental conditions indicate a lack of proximity of the mobile device to the human ear.

7. The method of claim 1, wherein placing the mobile device in a state of lower power consumption, comprises suspending the mobile device.

8. A mobile device power management data processing system comprising:
a central processing unit (CPU) supported by a battery;
power management logic configured to manage utilization of the battery; and,
a proximity sensor coupled to the power management logic;
the power management logic comprising program code enabled to reduce utilization of the battery based upon a detected close proximity to a human ear.

9. The system of claim 8, wherein the sensor comprises a temperature sensor.

10. The system of claim 8, wherein the sensor comprises an audio reflectivity sensor.

11. A computer program product comprising a computer usable medium embodying computer usable program code for mobile device power management in a mobile device, the computer program product comprising:
computer usable program code for sensing environmental conditions associated with a proximity of the mobile device to a human ear;
computer usable program code for determining a period of inactivity from the sensed environmental conditions; and,
computer usable program code for responsive to determining a period of inactivity from the sensed environmental conditions, placing the mobile device in a state of lower power consumption.

12. The computer program product of claim 11, further comprising computer usable program code for notifying a companion device of the state of lower power consumption.

13. The computer program product of claim 11, further comprising:
computer usable program code for continuing to sense environmental conditions associated with a proximity of the mobile device to a human ear;
computer usable program code for determining a period of activity from the sensed environmental conditions; and,
computer usable program code for, responsive to determining a period of activity from the sensed environmental conditions, placing the mobile device in a resumed state of power consumption.

14. The computer program product of claim 11, wherein the computer usable program code for sensing environmental conditions associated with a proximity of the mobile device to a human ear, comprises computer usable program code for sensing temperature conditions associated with a proximity of the mobile device to a human ear.

15. The computer program product of claim 11, wherein the computer usable program code for sensing environmental conditions associated with a proximity of the mobile device to a human ear, comprises computer usable program code for sensing audio reflectivity conditions associated with a proximity of the mobile device to a human ear.

16. The computer program product of claim 11, wherein the computer usable program code for determining a period of inactivity from the sensed environmental conditions, comprises computer usable program code for determining a period of inactivity based upon a lapsed threshold period of time during which the sensed environmental conditions indicate a lack of proximity of the mobile device to the human ear.

17. The computer program product of claim 11, wherein the computer usable program code for placing the mobile device in a state of lower power consumption, comprises computer usable program code for suspending the mobile device.
